(19) United States
(12) Patent Application Publication
(10) Pub. No.: US 2014/0164797 A1
(43) Pub. Date: Jun. 12, 2014

(54) PORTABLE ELECTRICAL DEVICE CHARGING SYSTEM AND METHOD USING THERMAL ENERGY

(71) Applicants: Jeffrey G. Marx, Chester Springs, PA (US); Lance A. Marx, University Park, PA (US)

(72) Inventors: Jeffrey G. Marx, Chester Springs, PA (US); Lance A. Marx, University Park, PA (US)

(21) Appl. No.: 14/100,185

(22) Filed: Dec. 9, 2013

Related U.S. Application Data
(60) Provisional application No. 61/735,250, filed on Dec. 10, 2012.

(51) Int. Cl. H02J 7/00; G06F 1/26; F21L 4/08

(52) U.S. Cl. CPC H02J 7/0052; F21L 4/085; G06F 1/26
USPC 713/300; 320/101; 362/183; 455/573

(57) ABSTRACT

A portable electrical device charging system and method for using thermal energy, especially for use in the field or as part of military operations, is disclosed. The inventive electrical device charging system has one or more thermal electric generators attached, physically connected to, or incorporated within a container or pouch that is used to heat packaged meals-ready-to-eat (“MRE”). With the generation of heat to cook the MRE, the heat transfer through the container or pouch activates the thermal electric generators which generates electricity, in the form of an electric current, that can be used to charge any electrical device including an electrical storage device. More particularly, the generated electrical current may be used to charge radios, batteries, cell phones, personal data assistant devices, tablets, cameras, flashlights, or any other similar device.

### FIELD OF THE INVENTION

The present invention relates generally to the field of electronic device charging systems and, in more particularity, to a portable device, system, and method for creating electricity using thermal energy to charge or power electronic devices. More specifically, the inventive device, system, and method, in preferred embodiments, use thermal electric generators incorporated with a container used to heat a packaged meal-ready-to-eat (“MRE”), such that the heat transfer from the chemical reaction of the MRE container to the thermal electric generator creates an electric current which is then used to charge any electrical device.

### BACKGROUND OF THE INVENTION

In any field operations where access to an electrical grid or electrical infrastructure is not readily available, or is not possible, the need to power electronic devices, or charge or recharge such devices is a recurring problem. Examples of such scenarios include camping trips or military field operations that are remote from the electric grid. Whether on a camping trip, or in military field operations, the need to keep radios, cell phones, laptops, tablets, global positioning devices (“GPS”), cameras, flashlights, or other electrical devices charged and operating is essential. Indeed, in certain situations, having such devices operating, may be critical for survival.

While carrying extra batteries is an answer to the need for electrical power in remote locations, the need to generate electricity in such locations, on a portable basis has been a problem that others have addressed, with some success. For example, there are portable solar electric generators that can be used to generate electricity from portable solar cells. Similar to carrying extra batteries, such portable solar cell devices may be heavy and not fully flexible. Wind power is another solution that may be used to generate limited electrical power where such wind conditions exist. Again, such devices may be cumbersome and heavy, and thus not readily portable.

Even with these and other attempts to solve the portable electrical power issue, there is still a need to be as efficient as possible to harness other forms of energy to create electricity. Heat energy is one such example that appears to not have been fully tapped for use to create portable electricity. Accordingly, to improve the technology for providing portable electrical energy, there is a need for devices, systems and methods for harnessing all forms of energy to generate remote or portable electricity.

The inventive device, systems and methods described herein particularly use the heat energy available to and used by campers, and military personnel, to heat and cook their packaged meals. More particularly, the inventive device, systems and methods harness the heat energy generated to heat meals-ready-to-eat (“MREs”) and convert that heat energy into an electrical current using one or more thermal electric generators (“TEGs”). One of the important attributes of such an inventive device and system is the use of heat energy that is already being carried by the soldier or camper, and accordingly, not needing to substantially increase or add to the equipment already being transported.

As such, the inventive device and system more efficiently converts energy being used for one purpose (e.g., cooking of food), and using it to create electrical energy, where such heat would otherwise simply be lost. The harnessing of such heat energy to create electricity has not been effectively achieved. The disclosed devices, systems and methods provide a solution to the problem of having a portable electrical charging device using heat energy created from MREs.

### SUMMARY OF THE INVENTION

The basic elements of the inventive portable electrical device charging system and method are one or more thermal electric generators, or thermoelectric generators (“TEGs”) directly attached to, or connected to, or incorporated within a container or pouch used to heat packaged food products. In an exemplary embodiment, the inventive portable electrical device charging system may be used in the field by military personnel as part of their equipment to heat meals-ready-to-eat (“MRE”), and thereby generate useable electricity to charge electronic devices, or batteries. A primary aspect or attribute of the inventive portable electrical device charging system is the ability to harness the heat energy generated as part of the field cooking of a MRE. Another preferred example or embodiment of the inventive portable electrical device charging system allows the TEG container to be used on camping or other field excursions to generate electricity to charge cellular devices, flashlights, laptops, cameras or any other similar electronic equipment. In still another preferred embodiment of the inventive portable electrical device charging system, the thermal energy from the food heating elements may be augmented by other heat sources, including solar energy. Such additional heat sources may provide longer duration of generated electrical current to be used to power electronic devices or to charge batteries.

The present invention is, in preferred embodiments, a portable system for generating an electric current for charging an electronic device, comprising at least one thermal electric generator, a container capable of holding at least one packaged food product and an appropriate amount of water, and a chemically activated heat source used for heating said at least one packaged food product wherein said at least one thermal electric generator is attached to said container, and said at least one thermal electric generator creates and electric current for charging an electronic device as a result of combining in said container, said chemically activated heat source with said at least one packaged food product, and said appropriate amount of water.

In a further aspect, the present invention is, in preferred embodiments, a method of charging an electronic device, using a portable system for generating an electric current, said portable system comprising at least one thermal electric generator, a container capable of holding at least one packaged food product and an appropriate amount of water; and a chemically activated heat source used for heating said at least one packaged food product, said method comprising the steps of placing said at least one packaged food product into said container; placing said chemically activated heat source into said container; adding said an appropriate amount of water into said container; and connecting said electronic device to said at least one thermal electric generator, wherein said chemically activated heat source creates heat within said container, thereby heating said at least one packaged food product, and heating said at least one thermal electric generator, thereby creating an electric current used to charge said electronic device.

### BRIEF DESCRIPTION OF THE DRAWINGS

FIG. 1 shows a front view of an exemplary embodiment of the portable electric charging system having a thermoelectric generator attached to or incorporated within the food cooking container;

FIG. 2 shows a back view of an exemplary embodiment of the portable electric charging system having a thermoelectric generator attached to or incorporated within the food cooking container;

FIG. 3 shows a side view of an exemplary embodiment of the portable electric charging system having a thermoelectric generator attached to or incorporated within the front and back of the food cooking container; and

FIG. 4 shows a front and back view of an exemplary embodiment of the portable electric charging system having a plurality of thermoelectric generators attached to or incorporated within the food cooking container.

### DETAILED DESCRIPTION OF PREFERRED EMBODIMENTS

The present invention discloses and teaches example portable devices, systems and methods for creating electricity using heat energy generated from chemically heating or cooking packaged food. The intention of the inventive portable electrical charging device and system is to harness the heat energy used to cook the packaged food, and then convert such heat energy to an electrical current, where such heat energy would otherwise be lost. The generated electrical current may be used to charge any type of electronic device.

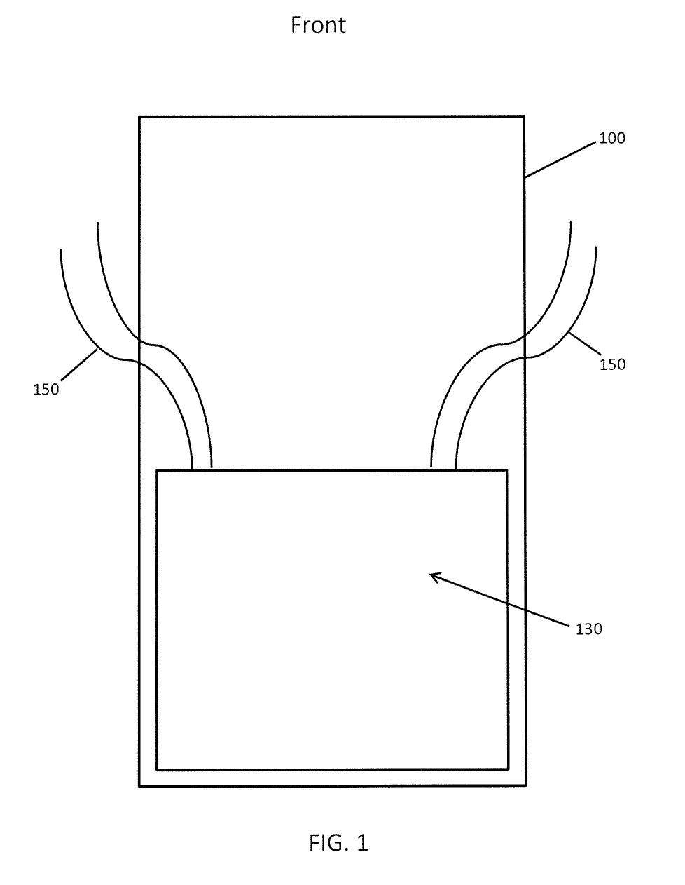

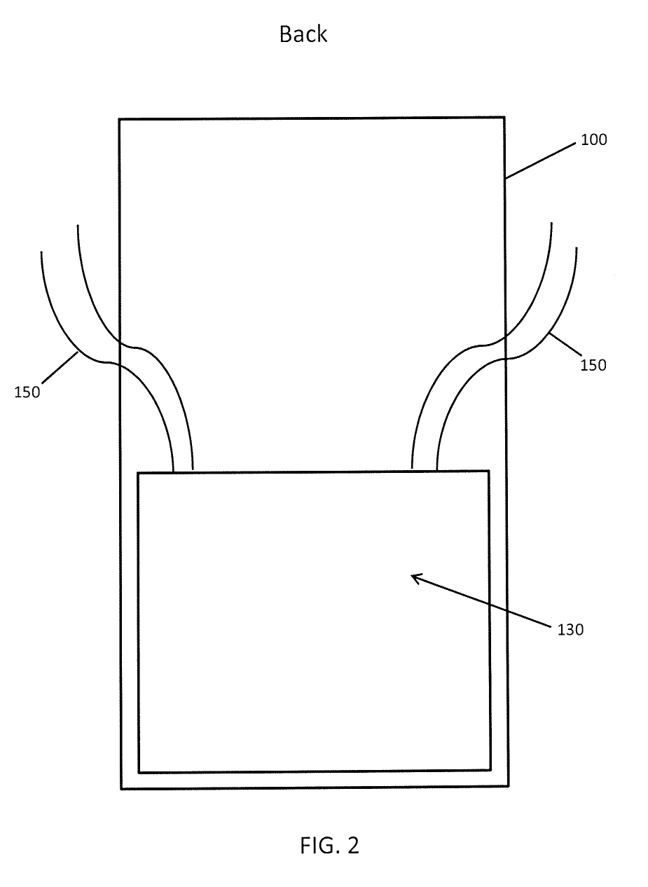

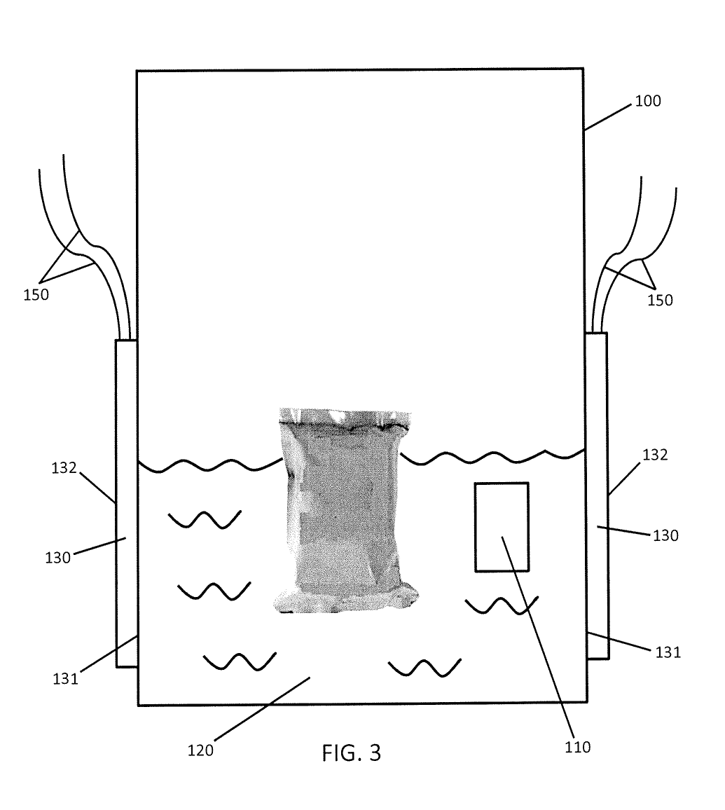

As illustrated in FIGS. 1 and 2, showing respectively a front and back view of an exemplary embodiment of the inventive device and system, there is as a core element, a container or pouch 100, that in military parlance, could be a MRE pouch. As illustrated in FIG. 3, the pouch 100 is designed to hold the MRE along with a chemical heat source 110, or a flameless ration heater, and water 120. Further, there are physically attached to or incorporated within the pouch 100, one or more thermoelectric generators (“TEGs”) 130.

In operation, the exemplary embodiment illustrated in FIGS. 1 through 3 generates electrical energy from the TEGs 130 as a result of the chemical reaction of the chemical heat source 110 with the added water 120, and the heat transfer to the TEGs 130. More specifically, the TEGs convert the heat energy, or the heat generated from the chemical heat source 110, after the heat source is place within the MRE pouch 100 with the water 120. In other words, once the user places the MRE within the MRE pouch 100, adds some water 120 to the MRE pouch 100, and then places the chemical heat source 110 within the MRE pouch 100, heat is generated from the chemical reaction of the chemical heat source 110 with the water 120. The generation of the heat in turn (a) raises the temperature of the interior of the MRE pouch 100, and (b) raises the temperature of the water 120, creating steam that then “cooks” the packaged food or MRE. As the interior of the MRE pouch 100 and water 120 temperature rises, the walls of the MRE pouch 100 accordingly also increase in temperature. With the increase in temperature of the MRE pouch 100 wall, the surface 131 of the TEG 130 that is in contact with the MRE pouch 100 wall is subject to heat transfer and an increase in temperature of the TEG surface 131 closest to the MRE pouch 100 wall.

The operation of a TEG device provides that with the difference in temperature of one surface of the TEG 131 as compared to the temperature of another, substantially opposite surface of the TEG 132, electrical energy will be generated. It is known that this thermoelectric effect can be created using bimetallic junctions, or using more recently developed technology, from bismuth telluride (Bi2Te3) or lead telluride (PbTe) semiconductor p and n junctions. Such semiconductor devices are very small, having thicknesses in the range of millimeters. Moreover, such semiconductor devices, being solid-state devices, have no moving parts, and accordingly are less likely to breakdown or be damaged in field use. Such devices, are also very light and easy to transport, again most applicable to mobile field use.

While any type of thermoelectric effect mechanism (present or future) may be used with the MRE pouch 100, in a preferred embodiment, it is expected that semiconductor type devices, such as the noted bismuth telluride (Bi2Te3) or lead telluride (PbTe) semiconductor p and n junctions, will provide higher system efficiencies considering weight and durability. As between bismuth telluride (Bi2Te3) or lead telluride (PbTe) semiconductor devices, the lead telluride embodiment may have a slightly higher weight, but given the size of such devices, the differences in weight are likely not substantial.

With respect to energy transfer efficiencies, such semiconductor thermoelectric devices have a range of energy transfer of approximately 5% to 10%. With advances in technology, it is expected that such devices will have increased and improved energy transfer efficiencies.

The chemical heat source 110 may be any form of flameless ration heater, and may be made from powdered food-grade iron, magnesium, and sodium. In preferred embodiments, the chemical heat source 110 may be an individually packaged in a leak-proof type of polybag.

As shown in FIGS. 1 through 4, the electricity or electrical current generated by the device is accessible from the MRE pouch 100/TEG 130 through the TEG output wires 150. Such wires could be readily connected to, solely by way of example, a battery charging device, or with the appropriate adapter, a radio, cell phone, laptop, tablet device, or other electronic device.

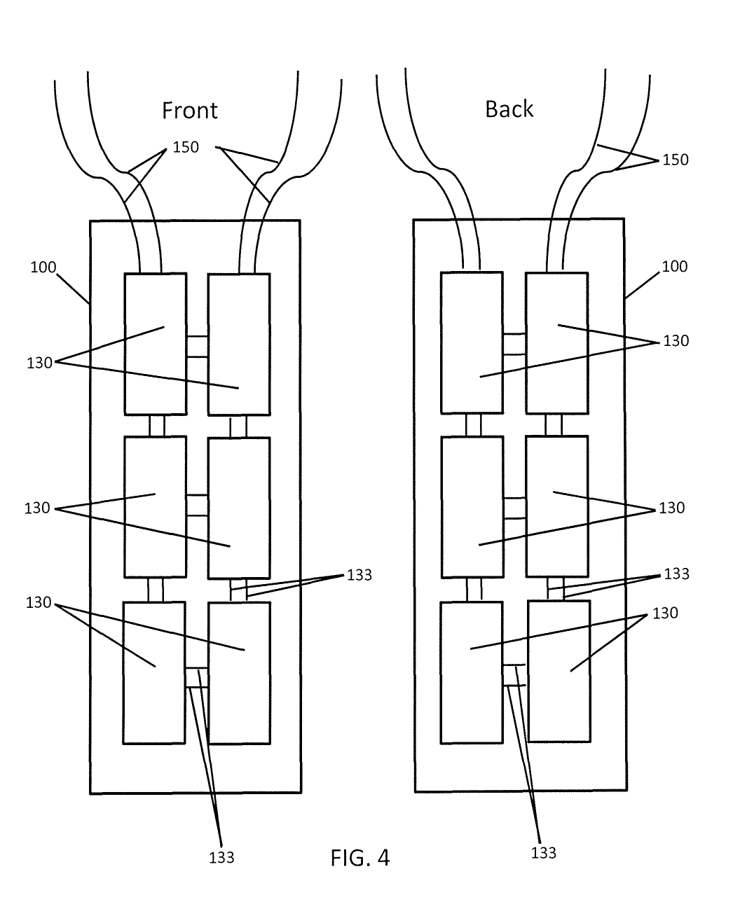

While FIGS. 1 through 3 illustrate use of a single TEG 130 on a front side and back side of the MRE pouch 100, in other preferred embodiments, the MRE pouch 100 could be manufactured having one or more TEGs 130 attached to or incorporated into one side of the pouch 100. Similarly, as illustrated in FIG. 4, for reasons of increased flexibility, or energy efficiency, the inventive MRE pouch 100 could be fabricated with a plurality of TEGs 130 attached to or incorporated within one or multiple sides of the pouch 100. Such TEGs 130 could be connected in series or parallel, as shown in FIG. 4, or such TEGs 130 could be independently operated to power separate electronic devices. The individual TEGs 130 are interconnected using interconnectors or wires 133. By way of example, for a preferred embodiment, with a plurality or multiple TEGs 130, individual TEGs 130 could be connected separately to a cell phone, a flashlight, a camera, or a GPS device.

The inventive portable electrical device charging devices and systems may also be used in combination with other energy or heat sources. For example, the energy output of the MRE pouch 130 could be augmented by also using solar cells (not shown) attached to, on or with the MRE pouch 100. In another preferred embodiment, the energy output of the MRE pouch 100 may be increased by using other heat sources to either increase the temperature of the inside wall of the TEG 131 or decrease the temperature of the outside wall of the TEG 132. By increasing the temperature differential of the TEG 130 walls, there is an increase in the electrical current generated. Such increase in temperature differential will also prolong the period of electrical current generation.

By way of one example, in a preferred embodiment, the outside wall 132 of the TEG 130 could be manufactured with an integral or attachable heat dissipator, such as fins. Other means of drawing heat away from the outside wall 132 of the TEG 130 include having an air current flow over or near the outside wall 132, or placing an ice-pack or water on or near the outside wall 132.

While the present invention is described herein with reference to illustrative embodiments for particular applications, it should be understood that the invention is not limited to those specific examples, and that there are equally possible systems using similar TEGs and heat sources. Those having ordinary skill in the art and access to the teachings provided herein will recognize additional modifications, applications, embodiments and substitution of equivalents all of which are within the scope of the inventive portable electric charging systems and methods. Accordingly, the invention is not to be considered as limited by the foregoing description.

What we claim is:

1. A portable system for generating an electric current for charging an electronic device, comprising:
a. at least one thermal electric generator;
b. a container capable of holding at least one packaged food product and an appropriate amount of water; and
c. a chemically activated heat source used for heating said at least one packaged food product;
wherein said at least one thermal electric generator is attached to said container, and said at least one thermal electric generator creates and electric current for charging an electronic device as a result of combining in said container, said chemically activated heat source with said at least one packaged food product, and said appropriate amount of water.

2. The portable system for generating an electric current for charging an electronic device, as described in claim 1, wherein the chemically activated heat source is a flameless ration heater.

3. The portable system for generating an electric current for charging an electronic device, as described in claim 1, wherein the at least one thermal electric generator is a semiconductor device using bismuth telluride (Bi2Te3) semiconductor p and n junctions.

4. The portable system for generating an electric current for charging an electronic device, as described in claim 1, wherein the at least one thermal electric generator is a semiconductor device using lead telluride (PbTe) semiconductor p and n junctions.

5. The portable system for generating an electric current for charging an electronic device, as described in claim 1, wherein the chemically activated heat source is made from powdered food-grade iron, magnesium, and sodium, and packaged in a leak-proof polybag.

6. The portable system for generating an electric current for charging an electronic device, as described in claim 1, wherein the generated electric current is used to charge one or more rechargeable batteries.

7. The portable system for generating an electric current for charging an electronic device, as described in claim 1, wherein the generated electric current is used to power an electronic device.

8. The portable system for generating an electric current for charging an electronic device, as described in claim 1, wherein the electronic device is a cellular telephone.

9. The portable system for generating an electric current for charging an electronic device, as described in claim 1, wherein the electronic device is a laptop computer.

10. The portable system for generating an electric current for charging an electronic device, as described in claim 1, wherein the electronic device is a tablet device.

11. The portable system for generating an electric current for charging an electronic device, as described in claim 1, wherein the electronic device is a flashlight.

12. The portable system for generating an electric current for charging an electronic device, as described in claim 1, wherein the electronic device is a radio.

13. The portable system for generating an electric current for charging an electronic device, as described in claim 1, wherein the electronic device is a global positioning locator device.

14. The portable system for generating an electric current for charging an electronic device, as described in claim 1, further comprising an augmenting heat source.

15. The portable system for generating an electric current for charging an electronic device, as described in claim 14, wherein the augmenting heat source is a solar energy collector.

16. The portable system for generating an electric current for charging an electronic device, as described in claim 1, further comprising at least one heat dissipator incorporated with the at least one thermal electric generator to increase temperature differential across said thermal electric generator.

17. The portable system for generating an electric current for charging an electronic device, as described in claim 1, having a plurality of thermal electric generators connected in series.

18. A method of charging an electronic device, using a portable system for generating an electric current, said portable system comprising at least one thermal electric generator, a container capable of holding at least one packaged food product and an appropriate amount of water; and a chemically activated heat source used for heating said at least one packaged food product, said method comprising the steps of:
a. placing said at least one packaged food product into said container;
b. placing said chemically activated heat source into said container;
c. adding said an appropriate amount of water into said container;
d. connecting said electronic device to said at least one thermal electric generator,
wherein said chemically activated heat source creates heat within said container, thereby heating said at least one packaged food product, and heating said at least one thermal electric generator, thereby creating an electric current used to charge said electronic device.

19. The method of charging an electronic device, using a portable system for generating an electric current, said portable system comprising at least one thermal electric generator, a container capable of holding at least one packaged food product and an appropriate amount of water; and a chemically activated heat source used for heating said at least one packaged food product, wherein said container capable of holding at least one packaged food product and an appropriate amount of water, and a chemically activated heat source is a packaged meal-read-to-eat.
